(19) United States
(12) Patent Application Publication
(10) Pub. No.: US 2005/0258658 A1
(43) Pub. Date: Nov. 24, 2005

(54) Cargo hook safety lock

(76) Inventors: Donald John Tollenaere, Seneca, SC (US); Christie Joeseph Croff, Monarch, MT (US)

Correspondence Address: MCNAIR LAW FIRM, PA, P.O. BOX 10827, GREENVILLE, SC, 29603-0827, US

(21) Appl. No.: 10/848,769

(22) Filed: May 20, 2004

(51) Int. Cl. B66C 1/36

(52) U.S. Cl. 294/82.31

(57) ABSTRACT

A latch housing with a load arm carried by the housing. A control latch assembly is included in the latch housing operatively controlling movement of the load arm between the open and closed positions. A latch override slot is included in the housing providing open direct passage to the control latch assembly from an exterior of the latch housing. A locking pin is carried by the housing adapted to be received in the latch override slot. The locking pin has a locked position inserted into the latch override slot wherein the pin extends into the housing and engages the control latch assembly to override operation of the control latch assembly and prevent movement of the load arm, and an unlocked position withdrawn from the latch override slot wherein the control latch assembly is free to operate the load arm between the open and closed positions.

### CROSS-REFERENCE TO RELATED APPLICATIONS

Cross-Referencing the US Patent Office and Trademark Office data base did not produce any Related Applications. Copies of the cross referencing inquiries are included with the application.

### FEDERALLY SPONSORED RESEARCH OR DEVELOPMENT

N/A

### BACKGROUND OF THE INVENTION

The present invention relates generally to all cargo hooks with mechanical and or electrical release mechanisms used for opening a cargo hook load beam and more specifically to opening a helicopter cargo hook load beam.

Helicopters typically are equipped with an external cargo hook, mounted directly under the center of gravity of the helicopter, for transporting loads which do not fit in the helicopter or are otherwise better delivered or extracted externally. External loads can include humans, animals and hazardous materials.

The prior art protecting against the inadvertent opening of the of the cargo hook load beam consists of cautionary devices such as protective release device covers, warning placards and bright contrasting coloring for identifying the release devices and or their covers. The current devices fail to provide a positive lock for the cargo hook load beam in the event of an inadvertent activation of the cargo hook electrical release device or the approved cargo hook mechanical release device.

### BRIEF SUMMARY OF THE INVENTION

The Cargo Hook Safety Lock is comprised of a double ball lock quick release safety pin (hereinafter referred to as a pin or the pin) that when inserted into a predetermined location of a cargo hook restricts the movement of a cargo hook lever arm release mechanism. When an electrical release device is used with a mechanical release device the electrical solenoid bell crank of the electrical device and the mechanical manual release cam connect to the lever arm and move in unison with the lever arm. Thus the restriction resulting from the insertion of a pin into a pre determined safety lock hole or blocking position prohibits the load beam from being opened manually or electrically. The advantages of the invention are; it provides a higher level of safety, not previously available, for safer transport of live loads and critical cargo. The object of the invention is to provide a new, higher level of safety for helicopters used for rescue, disaster relief and military operations. The advantages and object are accomplished by prohibiting the movement of the cargo hook release lever and thus prohibiting the inadvertent release of the cargo hook load beam. Once a pin is in a safety lock hole or blocking position the mechanical and or electrical load beam opening devices are unable to release a cargo hook load beam. Since the lever arm, electrical solenoid bell crank and mechanical release are connected and interact in unison, placement of a pin to restrict the movement of any one of the three devices will prohibit movement of all three devices and the load beam

### DESCRIPTION OF DRAWINGS

There are three computer drawings each showing a three dimensional view of a cargo hook with a pin. The drawings are identified as; FIG. 1, FIG. 2 and FIG. 3. Each drawing depicts the pin in one of three positions.

FIG. 1 depicts the pin in the stored position.

FIG. 2 depicts the pin in an alignment position prior to being inserted into a safety lock position.

FIG. 3 depicts the pin in a safety lock position.

FIG. 4 is side view drawing of a cargo hook with a cut away view depicting the internal release and locking mechanisms of a cargo hook and the cargo hook load beam.

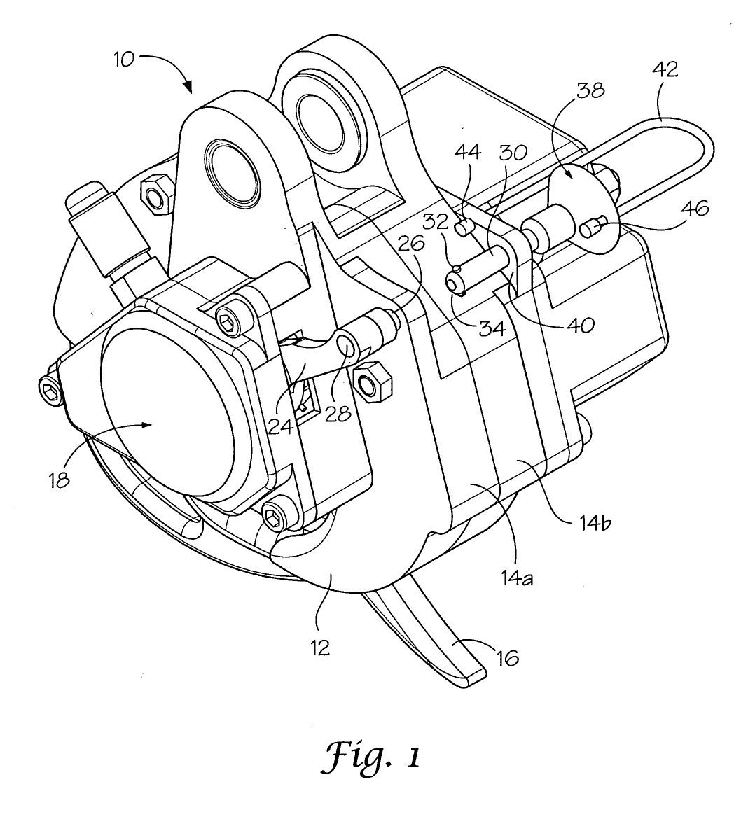

FIG. 1 depicts a securing lanyard 2 with a pin 1 in a stored position. It is located in one of the cargo hook's two side plates 3. The storing hole 4 is of sufficient size to allow a pin to be inserted into the storing position when its ball lock release button is depressed. When the ball lock release button is depressed the ball locks 5 recede into the shaft of the pin prior to the pin being inserted in the storing hole of the side plate. Once the pin is stored the push button release of the pin is released and the double ball locks return to an extended position increasing the diameter of the pin at the point. The increased pin diameter at the double ball lock location prohibits the removal of the pin through the storing hole. The pin will remain stored until it is manually removed by depressing the ball lock release button and extracting the pin from the storing hole.

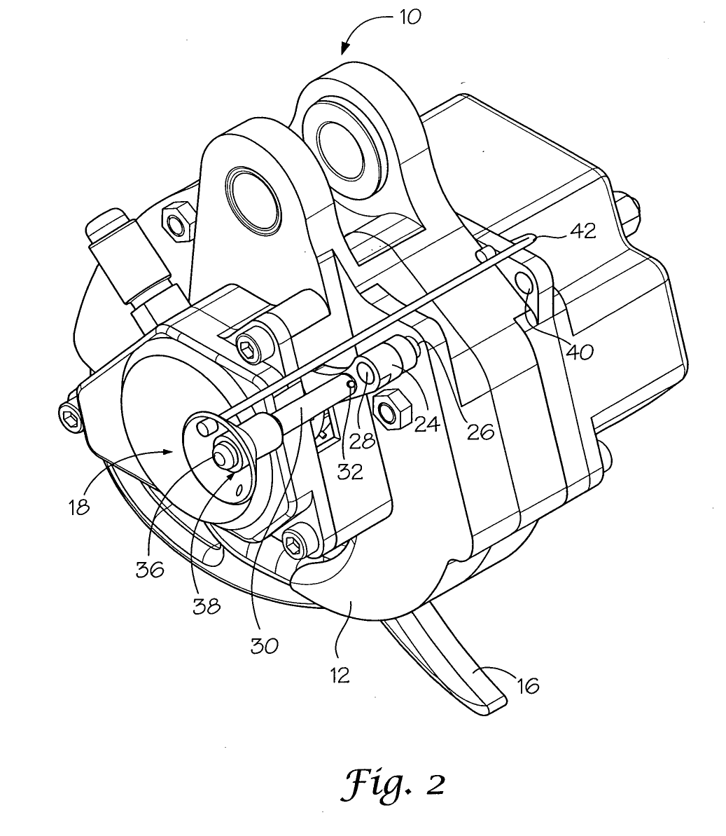

FIG. 2 depicts a pin 6 in an alignment position with the manual release arm 7 prior to its insertion into the manual release arm and cargo hook side plate 8

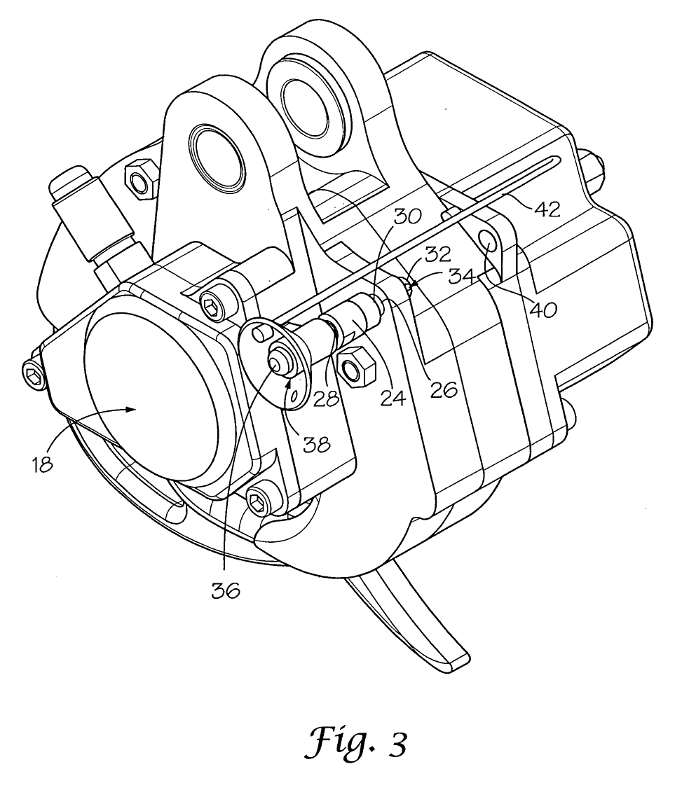

FIG. 3 depicts a pin with a push button release 9 in the safety lock position. The pin is depicted engaging both the manual release arm 10 and a side plate 11 of the helicopter cargo hook assembly.

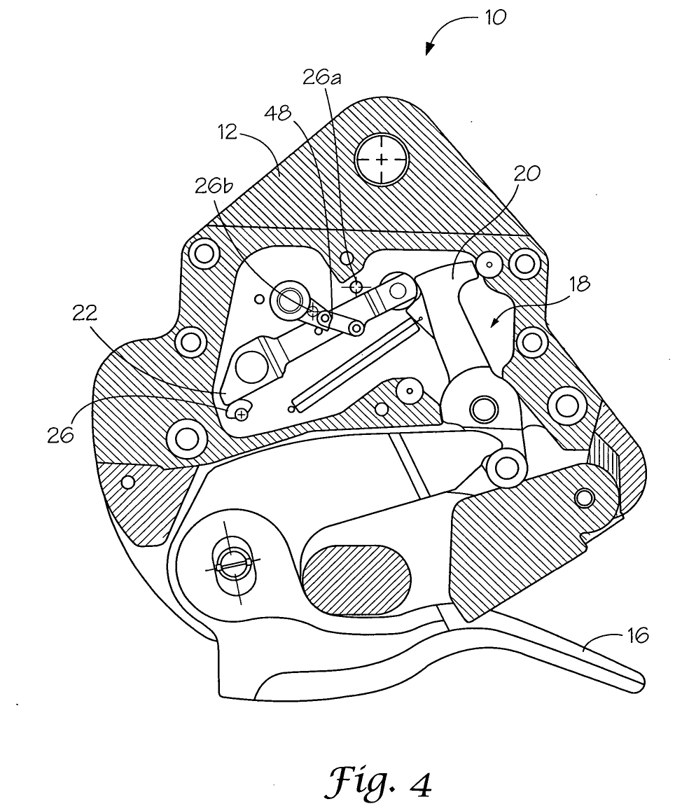

FIG. 4 shows a side view of a helicopter cargo hook and the load beam with a cut away section depicting the internal mechanisms that interconnect to release the load beam 12. The drawing shows the electrical solenoid bell crank 13 and the manual release cam 14 with both devices connecting and or contacting the release lever 15. The drawing identifies a safety lock hole alignment position adjacent to the lever arm 16 and in addition another safety lock hole alignment position through the electrical solenoid bell crank 17 and cargo hook side plates. Only one position is necessary to provide a load beam safety lock for a cargo hook. The depiction of two positions in FIG. 4 is for the sole purpose of illustrating another position option for a pin.

### OPERATION OF THE INVENTION

As shown in FIG. 1 the pin is in the stored position. To secure the load beam in a locked position the pin is removed from the stored position by depressing the push button release FIG. 3-9 and pulling the pin out of the stored position and then inserting the pin into a locking position as shown in FIG. 3. This particular locking position isolates the movement of the manual release cam FIG. 4-14. The manual release cam works in unison with electrical solenoid bell crank and the lever arm. The three components do not move without each other moving in concert. The lever arm FIG. 4-15 has to move to release the spring loaded lock FIG. 4-18 which in turn releases the load beam FIG. 4-12. Our invention prohibits the movement of the spring loaded lock by prohibiting the movement of the lever arm and or the electrical solenoid bell crank and or the manual release cam.

Accordingly, isolating the movement of the electrical solenoid bell crank FIG. 4-13 will also effectively prohibit the movement of the lever arm.

Accordingly, inserting a pin through the cargo hook side plates adjacent to the lever arm FIG. 4-16 or through the lever arm FIG. 4-15 will effectively prohibit the movement of the lever arm.

To unlock the cargo hook load beam depress the push button release of the pin, remove it from the lock position, and position it into the stored position. Releasing the push button release of the pin at this juncture will lock the pin in the stored position.

1-2. (canceled)

3. A cargo hook having a manual release safety lock comprising:
a latch housing;
a load arm pivotally carried by said housing having an open position for receiving cargo and a closed position for releasing cargo;
a control latch assembly included in said latch housing operatively controlling movement of said load arm between said open and closed positions;
a latch override slot included in said housing providing open direct passage to said control latch assembly from an exterior of said latch housing;
a locking pin carried by said housing adapted to be received in said latch override slot; and,
said locking pin having a locked position inserted into said latch override slot wherein said pin extends into said housing and engages said control latch assembly to override operation of said control latch assembly and prevent movement of said load arm between said open and closed positions, and an unlocked position withdrawn from said latch override slot wherein said control latch assembly is free to operate said load arm between said open and closed positions.

4. The cargo hook of claim 3 wherein said control latch assembly includes a latch arm operatively associated with said load arm to control movement of said load arm between said open and closed positions; and a control arm included in said control latch assembly engaging said latch arm to block operational movement of said latch arm to prevent opening and closing of said load arm, and disengaging from said latch arm to allow operation of said latch arm to move said load arm; wherein said latch override slot is disposed adjacent said control arm so that said locking pin engages said control arm in said locked position to prevent said control arm from disengaging said latch arm to operate said load arm.

5. The cargo hook of claim 3 wherein said locking pin includes a ball lock disposed at a first distal end and a release button disposed at a second distal end; said release button operating said ball lock between a recessed condition allowing said locking pin to be inserted and withdrawn from said latch override slot, and an extended position preventing insertion and removal of said locking pin from said latch override slot.

6. The cargo hook of claim 3 including a holster carried on an exterior of said latch housing for storing said locking pin when withdrawn from said latch override slot.

7. The cargo hook of claim 3 including a tether having a first end affixed to said housing and a second end affixed to said locking pin to prevent accidental loss of said locking pin.

8. A cargo hook having a manual release safety lock comprising:
a latch housing including a control latch assembly;
a load arm pivotally carried by said housing being operatively controlled by said control latch assembly for moving between an open position for receiving cargo and a closed position for releasing cargo;
a manual release arm included in said control latch assembly carried on an exterior of said housing having a first position preventing said load arm from moving from said closed position to said open position, and a second position allowing said load arm to move between said open and closed positions;
a latch override slot included in said housing being adjacent said manual release arm when said manual release arm is in said first position;
a securing slot included in said manual release arm laterally aligned with said latch override slot when said manual release arm is in said first position; and,
a locking pin carried by said housing having a locked position inserted through said securing slot and said latch override slot for securing said manual release arm to said housing and preventing movement to said second position, and an unlocked position withdrawn from said securing slot and said latch override slot wherein said manual release arm is movable to said second position to allow operation of said load arm.

9. The cargo hook of claim 8 wherein said locking pin includes a ball lock disposed at a first distal end and a release button disposed at a second distal end; said release button operating said ball lock between a recessed condition allowing said locking pin to be inserted and withdrawn from said latch override slot and said securing slot, and an extended position preventing insertion and removal of said locking pin from said latch override slot and said securing slot.

10. The cargo hook of claim 8 including a holster carried on an exterior of said latch housing for storing said locking pin when withdrawn from said latch override slot and said securing slot.

11. The cargo hook of claim 8 including a tether having a first end affixed to said housing and a second end affixed to said locking pin to prevent accidental loss of said locking pin.

12. A cargo hook having a manual release safety lock comprising:
a latch housing;
a load arm pivotally carried by said housing having an open position for receiving cargo and a closed position for releasing cargo;
a control arm pivotally carried by said housing being operatively associated with said load arm; said control arm having a first position locking said load arm in said closed position, and a second position releasing said load arm to move between said open and closed positions;
an electric solenoid bell crank pivotally connected to said control arm for moving said control arm between said first and second positions;
a latch override slot included in said housing adjacent said electric solenoid bell crank for providing access to said bell crank from an exterior of said latch housing; and,
a locking pin carried by said housing having a locked position inserted through said latch override slot engaging said bell crank to prevent movement of said control arm to said second position, and an unlocked position withdrawn from said latch override slot wherein said bell crank is free to rotate said control arm to said second position to allow operation of said load arm.

13. The cargo hook of claim 12 including a securing slot included in said electric solenoid bell crank aligning with said latch override slot when said control arm is moved to said first position; wherein said locking pin is received into said securing slot of said bell crank in said locked position to prevent movement of said bell crank.

14. The cargo hook of claim 13 wherein said locking pin includes a ball lock disposed at a first distal end and a release button disposed at a second distal end; said release button operating said ball lock between a recessed condition allowing said locking pin to be inserted and withdrawn from said latch override slot, and an extended position preventing insertion and removal of said locking pin from said latch override slot.

15. The cargo hook of claim 12 including a holster carried on an exterior of said latch housing for storing said locking pin when withdrawn from said latch override slot.

16. The cargo hook of claim 12 including a tether having a first end affixed to said housing and a second end affixed to said locking pin to prevent accidental loss of said locking pin.
